(19) United States
(12) Patent Application Publication
(10) Pub. No.: US 2020/0216041 A1
(43) Pub. Date: Jul. 9, 2020

(54) Tire air extension

(71) Applicant: Emory J. Winston, Buffalo, NY (US)

(72) Inventor: Emory J. Winston, Buffalo, NY (US)

(21) Appl. No.: 16/201,310

(22) Filed: Jan. 3, 2019

(51) Int. Cl. B60S 5/04

(52) U.S. Cl. CPC B60S 5/04

(57) ABSTRACT

The present invention relates to tire inflation tools, the Tire Air Extension according to one embodiment of the present invention comprise of; a tire air valve, a dual air chuck both made onto opposite ends of a piece of light hollow metal 30″ length, with ⅛″ diameter. The present invention allows tire to be inflated from an upright, standing position. To inflate. Place dual air chuck onto tire air valve, then take air pump hose air chuck and place it onto the present invention tire air valve, then apply pressure. The air flows through the present invention objects and then into the tire.

### TECHNICAL FIELD

The present invention relates to tire inflation tools.

### BACKGROUND ART

In general, people use tire inflation tools in order to inflate tires. Because, an inflation tool of such is directly related to human body movements. The tire inflation tool must be made in such a way as not to cause the human body any physical discomfort.

Moreover, because of the way inflation tools are made, the tire Air Extension is provided to inflate tires at a standing upright position.

Conventionally, people use relatively short length inflation tools which can inflate tires, but such inflation tools have a problem in that the users body experiences physical discomfort and uncomfortable positions.

Recently, in order to solve this problem as tools for tire inflation, tire inflators short in length have been developed, and such technologies are disclosed in U.S. Pat. No. 2,285,569A, serial no. 331450.

However, such inflation tools have a disadvantage, in that they require users to inflate tires from an uncomfortable body positions, moreover, users must bend over, bend at the knees, and squat.

Meanwhile, tire inflation tools having a 12″ length has disadvantages, in that it requires the user to bend over and bend knees.

Therefore, the conventional tire inflator tools have limitations, because the user must move the body to uncomfortable positions.

Moreover, the conventional tire inflator tools, is an inconvenience to users because of the physical and uncomfortable positions.

Because people who own automobiles, must maintain proper air pressure in their tires on a regular basis. A different tire inflation tool can help to solve to the above mentioned problems.

Therefore, automobile owners demand a tire inflation tool that effectively can inflate tires in a physical and comfortable manner.

### Disclosure of Technical Problems

Accordingly, the present invention has been made in an effort, to solve the above mentioned problems occurring in the prior arts, it is the objects of the present invention to provide a tire inflation tool without uncomfortable body positions.

### Technical Solution

To achieve the above objective, the present invention provides the tire air extension including; a tire air valve, dual air chuck, both made on opposite ends of a 30″ length piece of light hollow metal ⅛″ diameter.

### Advantage Effects

As described above, the tire air extension tool according to the preferred embodiments of the above present invention provides the following effects:
First, a different longer length from the conventional tire inflation tools, the tire air extension according to the present invention provides the user to inflate the tire at a upright standing position
Second, the user of the conventional tire inflation tool must bend over, bend knees, and squat to inflate tire. The tire air extension according to the present invention provides elimination of the back bending, knee bending and pressure of the knees from squatting.
Third, different from the conventional tire inflation tools, the tire air extension according to the present invention provides users that have physical limitations easy use and comfortable body positions.
Fourth, differently from the conventional tire inflation tools, according to the present invention, provide the user to maintain an overall view of their surroundings while inflating the tires.

### DESCRIPTION OF DRAWINGS

FIG. 1, perspective side view of the Tire Air Extension.

FIG. 2, perspective front view of the Tire Air Extension.

FIG. 3, front view of the air valve.

FIG. 4, perspective top view of the air valve.

FIG. 5, perspective top view of the dual tire air chuck.

FIG. 6, perspective bottom view of the dual tire air chuck.

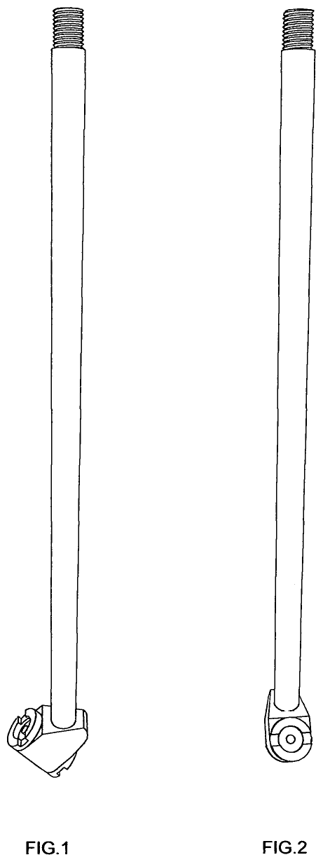

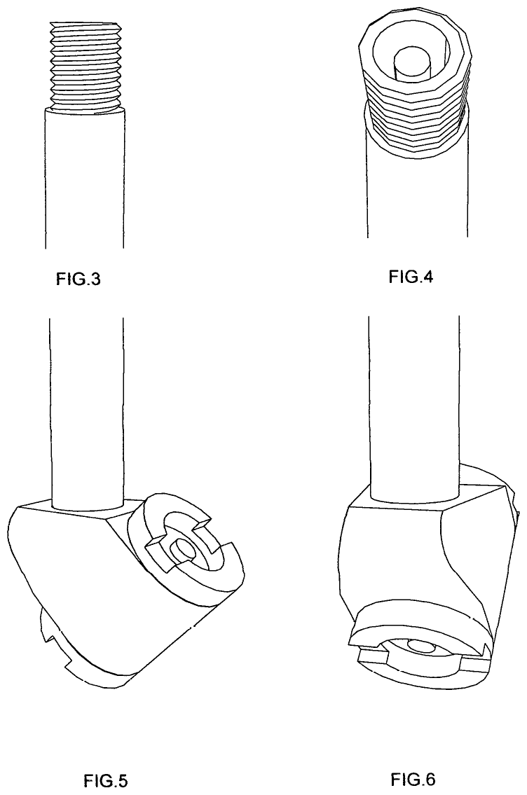

The invention claimed is:

1. Tire Air Extension Comprising; Tire Air Valve and a dual air chuck, both made onto opposite ends of a 30″ length piece of light hollow metal with ⅛″ diameter. The present invention allows users to inflate tires in an upright standing position.

2. The tire air extension according to claim 1, differs from conventional tire inflation tools in that the present invention has a 30″ extension.

3. The tire air extension according to claim 1, differs from the conventional tire inflation tools, according to the present invention, a tire air valve is made to one end of the 30″ metal piece. This object allows air to be released into the present invention.

4. The tire air extension according to claim 1 differs from conventional tire inflation tools, according to the present invention, a dual air chuck is made onto one end of the 30″ piece of ⅛″ diameter metal. This allows the air to flow into the automobile tire.
